(19) United States
(12) Patent Application Publication
(10) Pub. No.: US 2020/0250252 A1
(43) Pub. Date: Aug. 6, 2020

(54) DISTRIBUTED REMOTE DATA REQUEST OPERATOR

(71) Applicant: FORD GLOBAL TECHNOLOGIES, LLC, Dearborn, MI (US)

(72) Inventors: Benjamin M. ROCCI, Ann Arbor, MI (US); Mark Anthony ROCKWELL, Royal Oak, MI (US)

(21) Appl. No.: 16/266,027

(22) Filed: Feb. 2, 2019

(51) Int. Cl. G06F 16/9538; G07C 5/00

(52) U.S. Cl. CPC G06F 16/9538; G07C 5/008

(57) ABSTRACT

Diagnostic requirements specifying vehicle data requirements are received from requester devices. Vehicles and time periods for collection of diagnostic data from the vehicles are identified from the diagnostic requirements. The diagnostic data is periodically collected from the vehicles in accordance with the identification. The diagnostic data is compiled to create compiled data conforming to the diagnostic requirements. The compiled data is sent to the requester devices

### TECHNICAL FIELD

Aspects of the disclosure generally relate to a highly distributed remote data request operator.

### BACKGROUND

Automobile diagnostic data, such as Diagnostic Trouble Codes (DTCs), form compact, informative messages. Diagnostic data was designed to allow vehicle controllers to indicate a system fault and/or a need for repair.

### SUMMARY

In one or more illustrative examples, a system includes a server having a hardware processor. The processor is programmed to receive diagnostic requirements, specifying vehicle data requirements, from requester devices, identify, from the diagnostic requirements, vehicles and time periods for collection of diagnostic data from the vehicles, periodically collect the diagnostic data from the vehicles in accordance with the identification, compile the diagnostic data to create compiled data conforming to the diagnostic requirements, and send the compiled data to the requester devices.

In one or more illustrative examples, a method includes receiving diagnostic requirements, specifying vehicle data requirements, from requester devices; periodically sending diagnostic requests to vehicles per the diagnostic requirements, the vehicles being identified as matching vehicle selection criteria included in the diagnostic requests, the period for collection of data from the vehicles being identified according to a count of the vehicles and a quantity of data specified by the diagnostic requirements to be captured; periodically receiving, from the vehicles, a plurality of diagnostic data messages, each including a portion of the information requested according to the diagnostic requests; compiling data conforming to the diagnostic requirements into compiled data; and sending the compiled data to the requester devices.

In one or more illustrative examples, a non-transitory computer-readable medium comprising instructions that, when executed by a processor of a vehicle data server, cause the processor to receive diagnostic requirements, specifying vehicle data requirements, from requester devices; periodically send diagnostic requests to vehicles per the diagnostic requirements, the vehicles being identified as matching vehicle selection criteria included in the diagnostic requests, the period for collection of data from the vehicles being identified according to a count of the vehicles and a quantity of data specified by the diagnostic requirements to be captured; periodically receive, from the vehicles, a plurality of diagnostic data messages, each including a portion of the information requested according to the diagnostic requests; compile data conforming to the diagnostic requirements into compiled data; and send the compiled data to the requester devices.

### BRIEF DESCRIPTION OF THE DRAWINGS

FIG. 1 illustrates an example system implementing a distributed remote data request operator;

FIG. 2 illustrates an example diagram of the operation of the remote data request service to capture diagnostic data over a plurality of time periods; and

FIG. 3 illustrate an example process for compiling data from vehicles using a remote data requester service.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Over-the-air vehicle data is expensive when collected in uncontrolled high-volume amounts. Thus, the size of data to be collected over-the-air should be constrained. However, vetting and executing an over-the-air data request requires time and effort. Ideally, a large sample of data is to be garnered per data request execution act. In order to achieve value from over-the-air data collection, it is desirable for the request execution process to return high-value data from a statistically-representative sample size.

An improved over-the-air data collection application may be programmed to automate requesting data to execute over-the-air data requests to statistically random samples of a user-defined variety in a user-defined cadence and size. In an example, a User A may request 100 bytes of data from 1,000,000 red 4×4 vehicles over the next 30 days. This data request information may be provided to a highly-distributed remote data request service. The remote data request service may be configured to hook into a vehicle selection tool, as well as to perform the data request to a desired set of vehicles of the desired type each day. Continuing with the example of 100 bytes of data from 1,000,000 vehicles, the system may request 100 bytes of data from 33,333 each day of a month. Further aspects are discussed in detail herein.

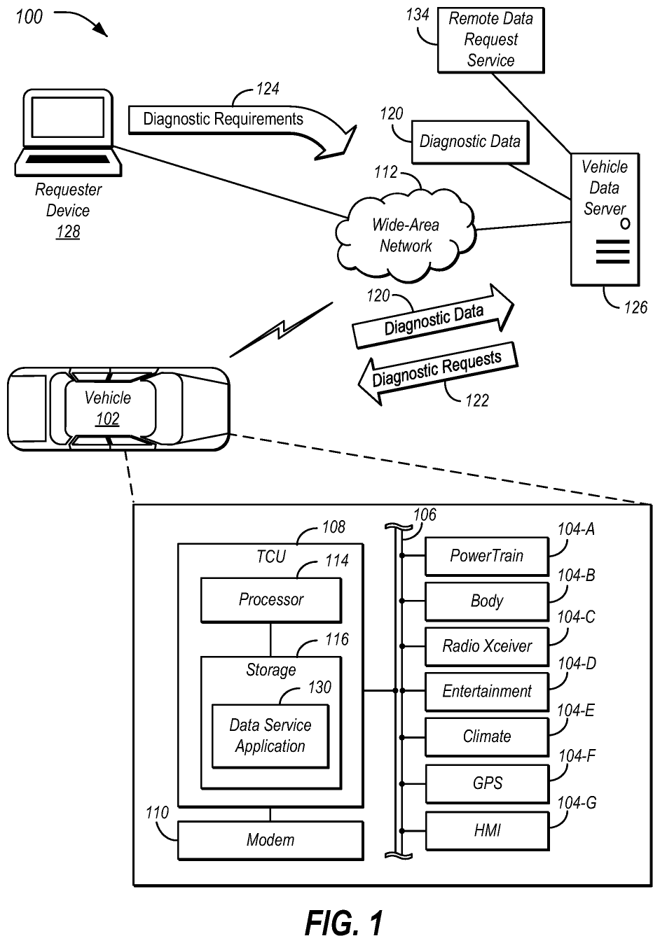

FIG. 1 illustrates an example system 100 implementing a distributed remote data request operator. As illustrated, a vehicle 102 includes a plurality of vehicle controllers 104 in communication over one or more vehicle buses 106. The system 100 also includes a vehicle data server 126 configured to maintain diagnostic data 120 received from various vehicles 102. The vehicle 102 further includes a telematics control unit (TCU) 108 configured to send diagnostic data 120, including diagnostic information, to the vehicle data server 126. The TCU 108 may utilize a data service application 130 installed to the TCU 108 to process diagnostic requests 122 that define data to be retrieved from the vehicle 102, and send diagnostic data 120 to the vehicle data server 126. The vehicle data server 126 may utilize a remote data request service 134 to determine, based on diagnostic requirements 124, which vehicles 102 are to receive which diagnostic requests 122, as well as to receive and compile the diagnostic data 120. It should be noted that the system 100 is merely an example, and other arrangements or combinations of elements may be used.

The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). As the type and configuration of vehicle 102 may vary, the capabilities of the vehicle 102 may correspondingly vary. As some other possibilities, vehicles 102 may have different capabilities with respect to passenger capacity, towing ability and capacity, and storage volume. For title, inventory, and other purposes, vehicles 102 may be associated with unique identifiers, such as VINs.

The vehicle 102 may include a plurality of controllers 104 configured to perform and manage various vehicle 102 functions under the power of the vehicle battery and/or drivetrain. As depicted, the example vehicle controllers 104 are represented as discrete controllers 104-A through 104-G. However, the vehicle controllers 104 may share physical hardware, firmware, and/or software, such that the functionality from multiple controllers 104 may be integrated into a single controller 104, and that the functionality of various such controllers 104 may be distributed across a plurality of controllers 104.

As some non-limiting vehicle controller 104 examples: a powertrain controller 104-A may be configured to provide control of engine operating components (e.g., idle control components, fuel delivery components, emissions control components, etc.) and for monitoring status of such engine operating components (e.g., status of engine codes); a body controller 104-B may be configured to manage various power control functions such as exterior lighting, interior lighting, keyless entry, remote start, and point of access status verification (e.g., closure status of the hood, doors and/or trunk of the vehicle 102); a radio transceiver controller 104-C may be configured to communicate with key fobs, mobile devices, or other local vehicle 102 devices; an entertainment controller 104-D may be configured to support voice command and BLUETOOTH interfaces with the driver and driver carry-on devices; a climate control management controller 104-E may be configured to provide control of heating and cooling system components (e.g., compressor clutch, blower fan, temperature sensors, etc.); a global positioning system (GPS) controller 104-F may be configured to provide vehicle location information; and a human-machine interface (HMI) controller 104-G may be configured to receive user input via various buttons or other controls, as well as provide vehicle status information to a driver, such as fuel level information, engine operating temperature information, and current location of the vehicle 102.

The vehicle bus 106 may include various methods of communication available between the vehicle electronic control units (ECUs) 104, as well as between the TCU 108 and the vehicle ECUs 104. As some non-limiting examples, the vehicle bus 106 may include one or more of a vehicle controller area network (CAN), an Ethernet network, and a media-oriented system transfer (MOST) network. Further aspects of the layout and number of vehicle buses 106 are discussed in further detail below.

The TCU 108 may include network hardware configured to facilitate communication between the vehicle ECUs 104 and with other devices of the system 100. For example, the TCU 108 may include or otherwise access a cellular modem 110 configured to facilitate communication with a wide-area network 112. The wide-area network 112 may include one or more interconnected communication networks such as the Internet, a cable television distribution network, a satellite link network, a local area network, and a telephone network, as some non-limiting examples. As another example, the TCU 108 may utilize one or more of BLUETOOTH, Wi-Fi, or wired USB network connectivity to facilitate communication with the wide-area network 112 via the user's mobile device.

The TCU 108 may further include various types of computing apparatus in support of performance of the functions of the TCU 108 described herein. In an example, the TCU 108 may include one or more processors 114 configured to execute computer instructions, and a storage 116 medium on which the computer-executable instructions and/or data may be maintained. A computer-readable storage medium (also referred to as a processor-readable medium or storage 116) includes any non-transitory (e.g., tangible) medium that participates in providing data (e.g., instructions) that may be read by a computer (e.g., by the processor(s)). In general, the processor 114 receives instructions and/or data, e.g., from the storage 116, etc., to a memory and executes the instructions using the data, thereby performing one or more processes, including one or more of the processes described herein. Computer-executable instructions may be compiled or interpreted from computer programs created using a variety of programming languages and/or technologies, including, without limitation, and either alone or in combination, JAVA, C, C++, C#, FORTRAN, PASCAL, VISUAL BASIC, PYTHON, JAVA SCRIPT, PERL, PL/SQL, etc.

The TCU 108 may be configured to include one or more interfaces from which vehicle information may be sent and received. In an example, the TCU 108 may be configured to facilitate the collection of DTC data and/or other vehicle information from the vehicle controllers 104 connected to the one or more vehicle buses 106. While only a single bus 106 is illustrated, it should be noted that in many examples, multiple vehicle buses 106 are included, with a subset of the controllers 104 connected to each bus 106. Accordingly, to access a given controller 104, the TCU 108 may be configured to maintain a mapping of which buses 106 are connected to which controllers 104, and to access the corresponding bus 106 for a controller 104 when communication with that particular controller 104 is desired.

The collected information retrieved from the controllers 104 over the vehicle buses 106 may be referred to as diagnostic data 120. The TCU 108 may store the collected diagnostic data 120 to the storage 116 of the TCU 108 or, in other examples, to other storage in communication with the TCU 108. The vehicle information retrieved by the TCU 108 may include, as some non-limiting examples, accelerator pedal position, steering wheel angle, vehicle speed, vehicle location (e.g., GPS coordinates, etc.), vehicle unique identifier (e.g., VIN), engine revolutions per minute (RPM), and vehicle HMI information, such as steering wheel button press information. Thus, diagnostic data 120 may include collected DTC information and/or other vehicle information stored to the storage 116 of the TCU 108.

The diagnostic requests 122 include information defining diagnostic elements, codes, or other information to be captured from the vehicles 102. The diagnostic requests 122 may be sent to the vehicle 102, and the vehicle 102 may return the diagnostic data 120 in response.

Diagnostic requirements 124 may be used to define data request information that indicates the diagnostic codes or other information to be requested from the vehicles 102 as diagnostic data 120 via diagnostic requests 122. The diagnostic requirements 124 may further include vehicle selection criteria that specify attributes of the vehicles 102 that should provide the diagnostic data 120. In an example, these attributes may include one or more of: a make of a vehicle 102, a model of a vehicle 102, a model year of a vehicle 102, a vehicle identification number (VIN) of a vehicle 102, or a VIN range of vehicle 102. The diagnostic requirements 124 may also include sample size information indicative of a quantity of diagnostic data 120 and/or vehicles 102 to provide the diagnostic data 120.

The vehicle data server 126 and a requester device 128 may each include various types of computing apparatus, such as a computer workstation, a server, a desktop computer, a virtual server instance executed by a mainframe server, or some other computing system and/or device. Similar to the TCU 108, the vehicle data server 126 and the requester device 128 generally include a memory on which computer-executable instructions may be maintained, where the instructions may be executable by one or more processors (not shown for clarity). Such instructions and other data may be stored using a variety of computer-readable media. In an example, the vehicle data server 126 may be configured to maintain the diagnostic data 120 received from the TCU 108 of the vehicles 102 by way of the network 112.

The requester device 128 may be used to allow an operator to configure the diagnostic requirements 124 that are used by the vehicle data server 126 to send the diagnostic requests 122. In an example, a user of the requester device 128 may specify one or more diagnostic codes to be captured from a set of vehicles 102. The user may also specify what vehicles 102 are intended to receive the diagnostic requests 122 (e.g., make, model, VIN range, etc.), as well other details such as how much diagnostic data 120 to collect, from how many vehicles 102 to collect the diagnostic data 120, and over what timeframe to collect the diagnostic data 120.

The data service application 130 may be one application included on the storage 116 of the TCU 108. The data service application 130 may include instructions that, when executed by the processor 114 of the TCU 108, cause the TCU 108 to perform functions periodically and/or in response to receipt of the diagnostic requests 122 from the vehicle data server 126. These functions may include to periodically collect the diagnostic data 120 information from the controllers 104 (e.g., including DTC information) based on diagnostic requests 122 received from the vehicle data server 126, store the information for transmission, and transmit the diagnostic data 120 to the vehicle data server 126 over the wide-area network 112.

The remote data request service 134 may be one application included on the storage of the vehicle data server 126. The remote data request service 134 may include instructions that, when executed by the processor of the vehicle data server 126, cause the vehicle data server 126 to receive the diagnostic data 120 information from vehicles 102, receive diagnostic requirements 124 from the requester device 128, convert the diagnostic requirements 124 into diagnostic requests 122, and provide diagnostic requests 122 to the vehicles 102. The remote data request service 134 may further receive the diagnostic data 120 from the vehicles 102 and compile the overall results to fulfil the requirements specified by the diagnostic requirements 124.

The remote data request service 134 may, accordingly, provide this information pursuant to the diagnostic requests 122 for analysis. In an example, the compiled information may be made available to the requester device 128 specifying the diagnostic requirements 124 from which the diagnostic requests 122 were generated.

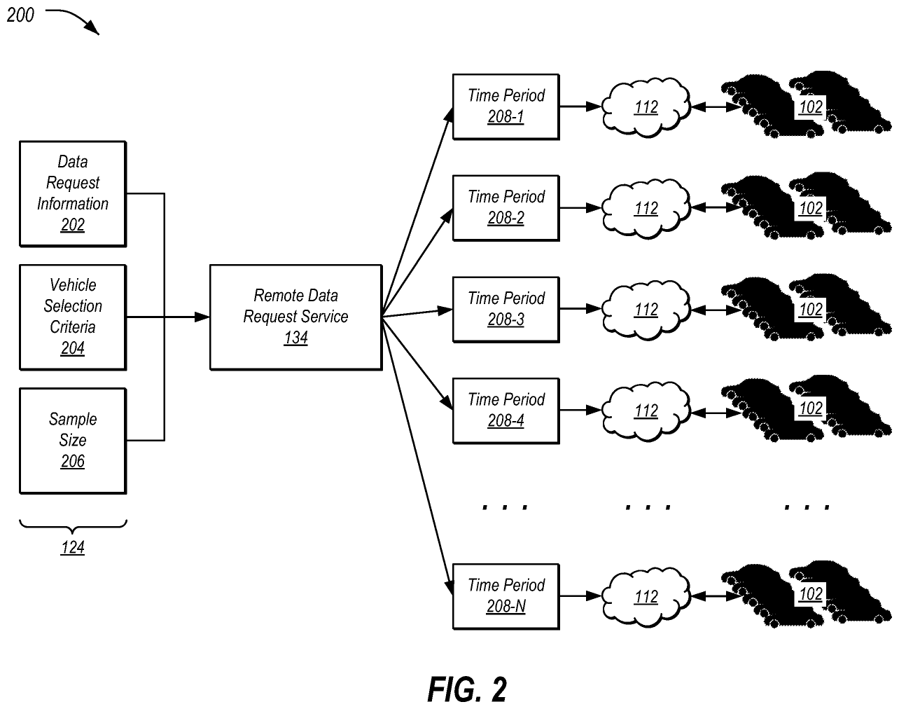

FIG. 2 illustrates an example diagram 200 of the operation of the remote data request service 134 to capture diagnostic data 120 over a plurality of time periods 208-1 through 208-N (collectively 208). As shown, the remote data request service 134 receives diagnostic requirements 124. The diagnostic requirements 124 may include data request information 202, vehicle selection criteria 204, and a sample size 206. In an example, the diagnostic requirements 124 may be received from the requester device 128.

The data request information 202 includes information indicative of what data is to be collected from the vehicles 102. In an example, the data request information 202 indicates the diagnostic codes or other information to be requested from the vehicles 102 as diagnostic data 120 via diagnostic requests 122. In another example, the data request information 202 may simply indicate that a certain quantity of bus traffic data is desired.

The vehicle selection criteria 204 includes information that specifies attributes of the vehicles 102 that should provide the diagnostic data 120. In an example, these attributes may include one or more of: a make of a vehicle 102, a model of a vehicle 102, a model year of a vehicle 102, a vehicle identification number (VIN) of a vehicle 102, or a VIN range of vehicle 102. Other vehicle selection criteria 204 may be used as well that relates to one or more vehicle 102 features, such as vehicle color, whether a vehicle is 2-wheel or 4-wheel drive, whether a vehicle includes a sunroof, and so on.

The sample size 206 includes information indicative of a quantity of diagnostic data 120 and/or vehicles 102 to provide the diagnostic data 120. In an example, the sample size 206 may indicate a quantity of data in bytes to be retrieved. Additionally or alternately, the sample size 206 may include a period of time over which the quantity of data is to be retrieved.

Based on the sample size 206, the remote data request service 134 determines a set of time periods 208 during which diagnostic requests 122 for the data request information 202 are to be sent to vehicle 102 matching the vehicle selection criteria 204. For instance, to use the example of a request for 100 bytes of data from 1,000,000 red 4×4 vehicles over the next 30 days, the remote data request service 134 determines a set of vehicles 102 that are red and 4×4, and then identifies a set of periodic time periods 208 over the 30 days to request data. For instance, if 33,333 vehicles 102 are identified, the remote data request service 134 may request 100 bytes of data from the 33,333 vehicles 102 for each day of a month. These diagnostic requests 122 may be sent from the vehicle data server 126, under the direction of the remote data request service 134, to the vehicles 102 over the wide-area network 112. As another example, the remote data request service 134 may identify a quantity of vehicles 102 matching the diagnostic requirements 124 from which to periodically collect the diagnostic data 120, identify a period for collection of a total quantity of data specified by the diagnostic data 120 by dividing the total quantity of data by a sample size 206 specified by the diagnostic requirements 124 times the quantity of matching vehicles 102, and periodically collect the diagnostic data 120 from the matching vehicles 102 according to the period using the sample sizes to generate diagnostic data 120 in an amount of the total quantity of data.

The vehicles 102 may receive the diagnostic requests 122, which may be processed by the data service application 130 of the TCU 108 to generate diagnostic data 120. This diagnostic data 120 may then be sent from the TCU 108 over the wide-area network 112 back to the vehicle data server 126 for collection by the remote data request service 134.

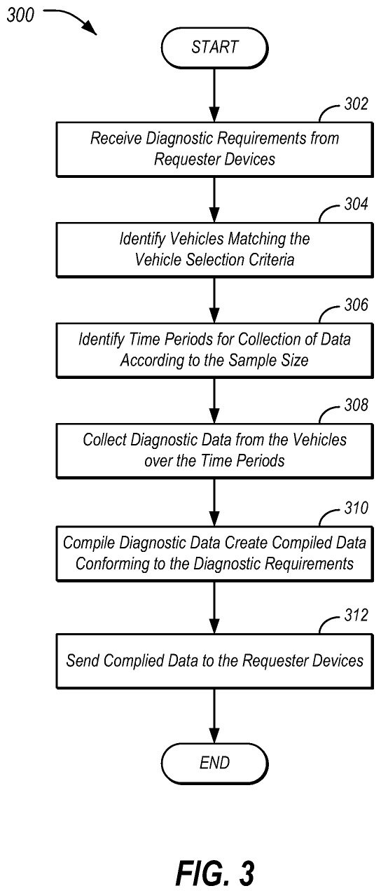

FIG. 3 illustrate an example process 300 for compiling data from vehicles 102 using a remote data request service 134. In an example, the process 300 may be performed by the vehicle data server 126 executing the remote data request service 134.

At operation 302, the vehicle data server 126 receives diagnostic requirements 124 from requester devices 128. In an example, the diagnostic requirements 124 define the data request information 202, vehicle selection criteria 204, and sample size 206 that is to be specified in the diagnostic requests 122 to the vehicles 102.

At 304, the vehicle data server 126 identifies vehicles 102 matching the vehicle selection criteria 204 of the diagnostic requirements 124. In an example, the vehicle data server 126 may access a vehicle selection tool or other database from which vehicle 102 attributes can be queried as matching the vehicle selection criteria 204.

At 306, the vehicle data server 126 identifies time periods 208 for the collection of diagnostic data 120 according to the sample size 206 information of the diagnostic requirements 124. In an example, based on the timeframe for the collection of diagnostic data 120, and the amount of vehicles 102 identified at operation 304 according to the vehicle selection criteria 204, the vehicle data server 126 identifies how many time periods 208 are required to perform. For instance, if 100 matching vehicles 102 are found to each provide 100 bytes of data, then ten time periods 208 may be used, but if only ten vehicles 102 are found, then 100 time periods 208 may be used.

At 308, the vehicle data server 126 collects diagnostic data 120 from the vehicles 102 over the time periods 208. In an example, the vehicle data server 126 sends the diagnostic requests 122 to the vehicles 102 per the vehicle selection criteria 204 and the sample size 206. Additionally, the vehicle data server 126 receives diagnostic data 120 from the vehicles 102. In an example, the diagnostic data 120 information may be received over the wide-area network 112 as transmitted by the vehicles 102.

At 310, the vehicle data server 126 compiles the diagnostic data 120 conforming to the diagnostic requirements 124. By using the diagnostic data 120 received over the time periods 308 from the vehicles 102, the vehicle data server 126 can gather together the data that was required. At 312, the vehicle data server 126 sends the compiled data to the requester devices 128. Accordingly, the requester devices 128 may access and otherwise utilize the diagnostic data 120 that was specified by the diagnostic requirements 124. After operation 312, the process 300 ends.

Thus, the disclosed systems and methods significantly reduce the overhead for executing OTA requests as compared to systems that perform one data request one data response. Moreover, the described systems and methods may automatically return a user defined sample size of data, without requiring the user of many individual requests. Additionally, the describe systems and methods spread out the sampling of data over a period of time which allows for control against external factors.

Yet further the system may maintain records of which vehicles 102 were providers of what data, allowing customers of OTA data collection to be able to receive a paper trail for traceability and governance purposes. Moreover, any enablers (on vehicle or in cloud) that facilitate data collection will be apparent when reviewing this paper trail.

Computing devices described herein, such as the TCU 108, vehicle data server 126, and requester device 128, generally include computer-executable instructions where the instructions may be executable by one or more computing devices such as those listed above. Computer-executable instructions, such as those of the data service application 130 or remote data request service 134, may be compiled or interpreted from computer programs created using a variety of programming languages and/or technologies, including, without limitation, and either alone or in combination, JAVA™, C, C++, C#, VISUAL BASIC, JAVASCRIPT, PYTHON, JAVASCRIPT, PERL, PL/SQL, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a server having a hardware processor programmed to
receive diagnostic requirements, specifying vehicle data requirements, from requester devices,
identify, from the diagnostic requirements, vehicles and time periods for collection of diagnostic data from the vehicles,
periodically collect the diagnostic data from the vehicles in accordance with the identification,
compile the diagnostic data to create compiled data conforming to the diagnostic requirements, and
send the compiled data to the requester devices.

2. The system of claim 1, wherein the diagnostic requirements include vehicle selection criteria specifying attributes of the vehicles from which to collect data.

3. The system of claim 2, wherein the diagnostic requirements include sample size information specifying an amount of data and period of time over which to collect the amount of data.

4. The system of claim 3, wherein the processor is further programmed to determine how many time periods for collection based on the sample size information and how many vehicles match the vehicle selection criteria.

5. The system of claim 1, wherein the processor is further programmed to collect the diagnostic data from the vehicles including operations to send diagnostic requests to the vehicles over a wide-area network and receive the diagnostic data from the vehicles over the wide-area network responsive to the diagnostic requests.

6. The system of claim 1, wherein the processor is further programmed to:
identify a quantity of vehicles matching the diagnostic requirements from which to periodically collect the diagnostic data;
identify a period for collection of a total quantity of data specified by the diagnostic data by dividing the total quantity of data by a sample size specified by the diagnostic requirements times the quantity of vehicles; and
periodically collect the diagnostic data according to the period using the sample sizes to generate compiled data in an amount of the total quantity of data.

7. A method comprising:
receiving diagnostic requirements, specifying vehicle data requirements, from requester devices;
periodically sending diagnostic requests to vehicles per the diagnostic requirements, the vehicles being identified as matching vehicle selection criteria included in the diagnostic requests, the period for collection of data from the vehicles being identified according to a count of the vehicles and a quantity of data specified by the diagnostic requirements to be captured;
periodically receiving, from the vehicles, a plurality of diagnostic data messages, each including a portion of the information requested according to the diagnostic requests;
compiling data conforming to the diagnostic requirements into compiled data; and
sending the compiled data to the requester devices.

8. The method of claim 7, further comprising storing the compiled data in a database.

9. The method of claim 7, further comprising identifying the vehicles matching the vehicle selection criteria by accessing a database of attributes of vehicles.

10. The method of claim 7, wherein the diagnostic requirements include vehicle selection criteria specifying attributes of the vehicles from which to collect data.

11. The method of claim 10, wherein the diagnostic requirements include sample size information specifying an amount of data and period of time over which to collect the amount of data.

12. The method of claim 11, further comprising determining how many time periods for collection based on the sample size information and how many vehicles match the vehicle selection criteria.

13. The method of claim 7, further comprising collecting the diagnostic data from the vehicles by sending diagnostic requests to the vehicles over a wide-area network and receiving the diagnostic data from the vehicles over the wide-area network responsive to the diagnostic requests.

14. A non-transitory computer-readable medium comprising instructions that, when executed by a processor of a vehicle data server, cause the processor to:
receive diagnostic requirements, specifying vehicle data requirements, from requester devices;
periodically send diagnostic requests to vehicles per the diagnostic requirements, the vehicles being identified as matching vehicle selection criteria included in the diagnostic requests, the period for collection of data from the vehicles being identified according to a count of the vehicles and a quantity of data specified by the diagnostic requirements to be captured;
periodically receive, from the vehicles, a plurality of diagnostic data messages, each including a portion of the information requested according to the diagnostic requests;
compile data conforming to the diagnostic requirements into compiled data; and
send the compiled data to the requester devices.

15. The medium of claim 14, further comprising instructions that, when executed by the processor cause the processor to store the compiled data in a database.

16. The medium of claim 14, further comprising instructions that, when executed by the processor cause the processor to identify the vehicles matching the vehicle selection criteria by accessing a database of attributes of vehicles.

17. The medium of claim 14, wherein the diagnostic requirements include vehicle selection criteria specifying attributes of the vehicles from which to collect data.

18. The medium of claim 17, wherein the diagnostic requirements include sample size information specifying an amount of data and period of time over which to collect the amount of data.

19. The medium of claim 18, further comprising instructions that, when executed by the processor cause the processor to determine how many time periods for collection based on the sample size information and how many vehicles match the vehicle selection criteria.

20. The medium of claim 14, further comprising instructions that, when executed by the processor cause the processor to collect the diagnostic data from the vehicles by sending diagnostic requests to the vehicles over a wide-area network and receiving the diagnostic data from the vehicles over the wide-area network responsive to the diagnostic requests.
